(19) United States
(12) Patent Application Publication
(10) Pub. No.: US 2014/0306805 A1
(43) Pub. Date: Oct. 16, 2014

(54) TAG APPARATUS FOR HIGH-RATE DATA TRANSMISSION AND COMMUNICATION METHOD THEREOF

(71) Applicant: Electronics and Telecommunications Research Institute, Daejeon (KR)

(72) Inventors: Jae-young JUNG, Daejeon (KR); Ji-Hoon BAE, Daejeon (KR); Won Kyu CHOI, Daejeon (KR); Kyu Won HAN, Seoul (KR); Chan-Won PARK, Daejeon (KR); Jong-Suk CHAE, Daejeon (KR); Cheol Sig PYO, Daejeon (KR); Hoe-Sung YANG, Daejeon (KR)

(73) Assignee: Electronics and Telecommunications Research Institute, Daejeon (KR)

(21) Appl. No.: 14/011,225

(22) Filed: Aug. 27, 2013

(30) Foreign Application Priority Data
Apr. 16, 2013 (KR) 10-2013-0041821

(51) Int. Cl. G06K 7/10

(52) U.S. Cl. CPC G06K 7/10009
USPC 340/10.1

(57) ABSTRACT

A tag apparatus communicating with a reader acquires a command from a signal that is received from the reader, converts data corresponding to the acquired command to a plurality of multi-level parallel data, and generates a plurality of tag load impedances based on bias voltages that are mapped to correspond to each level of the plurality of parallel data. Therefore, a signal having electrical energy corresponding to the plurality of tag load impedances is transmitted to the reader.

### CROSS-REFERENCE TO RELATED APPLICATION

This application claims priority to and the benefit of Korean Patent Application No. 10-2013-0041821 filed in the Korean Intellectual Property Office on Apr. 16, 2013, the entire contents of which are incorporated herein by reference.

### BACKGROUND OF THE INVENTION

(a) Field of the Invention

The present invention relates to a tag apparatus in which high-rate data transmission is possible, and a communication method thereof.

(b) Description of the Related Art

In general, in radio frequency identification (RFID) technology, a tag is attached to an object, an intrinsic identifier (ID) of the object that is stored at the tag is wirelessly recognized, and corresponding information is collected, stored, processed, and tracked, thereby determining a location of the object, performing remote processing and management of the object, and providing a service of information exchange between objects. Such technology does not require direct contact or scanning within a visible band like an existing barcode and is thus evaluated as technology to replace the barcode, and a use range thereof is increased.

An RFID system using such RFID technology is classified into a mutual induction method and an electromagnetic wave method according to a mutual communication method between a reader and a tag, is classified into a battery support type and a passive type according to whether a tag operates with its own power, and is classified into a low frequency band and a high frequency band according to a use frequency.

A system of a low frequency band (e.g., 30 kHz-500 kHz) is used at a short distance of, for example, 1.8 m or less, and a system of a high frequency band (e.g., 850 MHz-950 MHz or 2.45 GHz-2.5 GHz) is used at a large distance of, for example, 10 m or more. The RFID system recognizes information of an RFID tag within several meters by connecting an antenna to the RFID reader, and processes data thereof.

In communication of a UHF band (e.g., a 900 MHz band) RFID system, an RFID tag communicates with a reader using a backscattering-based load modulation method. Backscattering modulation is a method of changing a magnitude or a phase of scattered electromagnetic waves and sending tag information, when a tag scatters electromagnetic waves that are transmitted from a reader and returns the electromagnetic waves to the reader, and is a modulation method including and sending information in a carrier signal received from the reader by adjusting antenna impedance of the tag.

A signal transmitting method of an RFID tag using load modulation generally changes reflected electrical energy while switching load impedance of a tag to one of two states.

In general, when a real number value is varied, the signal becomes an amplitude shift keying (ASK) signal, and when an imaginary value is varied, the signal becomes a phase shift keying (PSK) signal. The tag may select ASK or PSK, and the reader should be able to demodulate both ASK and PSK, and thus in order to always demodulate a signal of the tag, most readers select a receiver of an in-phase (I)/quadrature-phase (Q) demodulation method.

A tag signal that is received through an antenna of the reader is converted to I and Q signals of a baseband through a mixer. The mixer uses a reference frequency that is generated in a local oscillator.

In a conventional RFID system, the tag has load impedance of two states, and such states may be divided into tag data of 1 bit. That is, in a backscattering modulation method using an antenna of one tag, because 1 bit representing a load impedance state is included in one symbol, a tag data transmission speed is inefficient compared with a communication method of 4-pulse amplitude modulation (PAM) and 2 bits/symbol, quadrature phase shift keying (QPSK) and 2 bits/symbol, and 4-quadrature amplitude modulation (QAM) and 2 bits/symbol having a multi-level.

### SUMMARY OF THE INVENTION

The present invention has been made in an effort to provide an apparatus and a method in which high-rate data transmission is possible between a tag and a reader in an RFID system.

An exemplary embodiment of the present invention provides a tag apparatus including: a demodulation unit that demodulates and outputs a signal received from an antenna for transmitting/receiving a signal from a reader; a memory that stores tag data to provide to the reader; a logic unit that acquires a reader command from the demodulated signal, acquires data corresponding to the reader command from the memory, converts the acquired data to a plurality of multi-level parallel data, and outputs bias voltages that are mapped to the plurality of parallel data; and a modulation unit that generates a plurality of tag load impedances according to bias voltages that are output from the logic unit.

The logic unit may store and manage bias mapping information to which bias voltages are mapped on a tag load impedance basis corresponding to each level, search for a bias voltage corresponding to the level from the bias mapping information, and provide the bias voltage to the modulation unit.

The modulation unit may include: a variable capacitor that operates as a variable capacitor according to the bias voltage; and a variable resistor that operates as a variable resistor according to the bias voltage, wherein tag load impedance corresponding to different levels may be generated by the variable capacitor and the variable resistor.

Another embodiment of the present invention provides a communication method of a tag apparatus, the communication method including: receiving a signal from a reader and demodulating the received signal; acquiring a reader command from the demodulated signal and converting data corresponding to the reader command to a plurality of multi-level parallel data; providing bias voltages that are mapped to the plurality of parallel data to a modulation unit and generating a plurality of tag load impedance corresponding to the bias voltages; and transmitting a signal having electrical energy corresponding to the tag load impedance to the reader.

The generating of a plurality of tag load impedances may include providing bias voltages that are mapped to each level of the plurality of parallel data to the modulation unit with reference to bias mapping information to which bias voltages are mapped on a tag load impedance basis corresponding to each level.

The generating of a plurality of tag load impedances may further include generating the plurality of tag load impedances using a PIN diode operating as a variable resistor according to a bias voltage and a varactor diode operating as a variable capacitor according to a bias voltage.

### BRIEF DESCRIPTION OF THE DRAWINGS

FIG. 1 is a diagram illustrating a structure of an RFID system according to an exemplary embodiment of the present invention.

FIG. 2 is a diagram illustrating a structure of a tag apparatus according to an exemplary embodiment of the present invention.

FIG. 3 is a diagram illustrating a structure of a modulation unit of a tag according to an exemplary embodiment of the present invention.

FIG. 4 is a Smith chart illustrating tag load impedance for multi-level modulation according to an exemplary embodiment of the present invention.

FIG. 5 is a flowchart illustrating a communication method of a tag apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a tag apparatus in which high-rate data transmission is possible and a communication method thereof according to an exemplary embodiment of the present invention will be described with reference to the drawings.

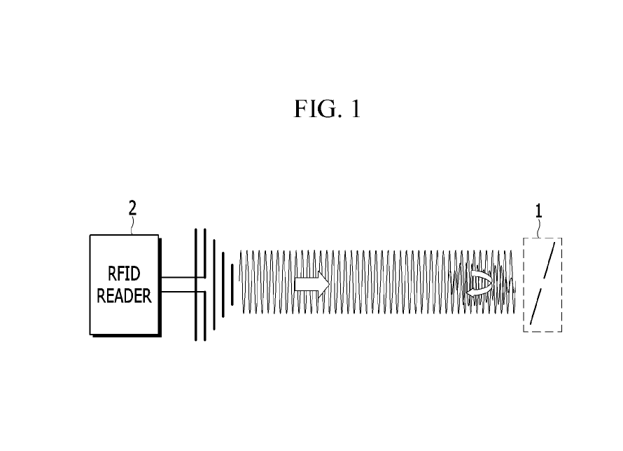

FIG. 1 is a diagram illustrating a structure of an RFID system according to an exemplary embodiment of the present invention.

As shown in FIG. 1, an RFID system according to an exemplary embodiment of the present invention includes a tag apparatus, i.e., a tag 1 and a reader 2, and the tag 1 and the reader 2 communicate with each other. Particularly, the tag 1 communicates with the reader 2 using a backscattering-based load modulation method. The tag 1 receives electromagnetic waves that are transmitted from the reader 2, scatters the electromagnetic waves, and returns the electromagnetic waves to the reader 2, and in this case, the tag 1 changes a magnitude or a phase of the scattered electromagnetic waves and sends tag information. The tag 1 includes and sends information in a carrier signal received from the reader 2 by adjusting antenna impedance.

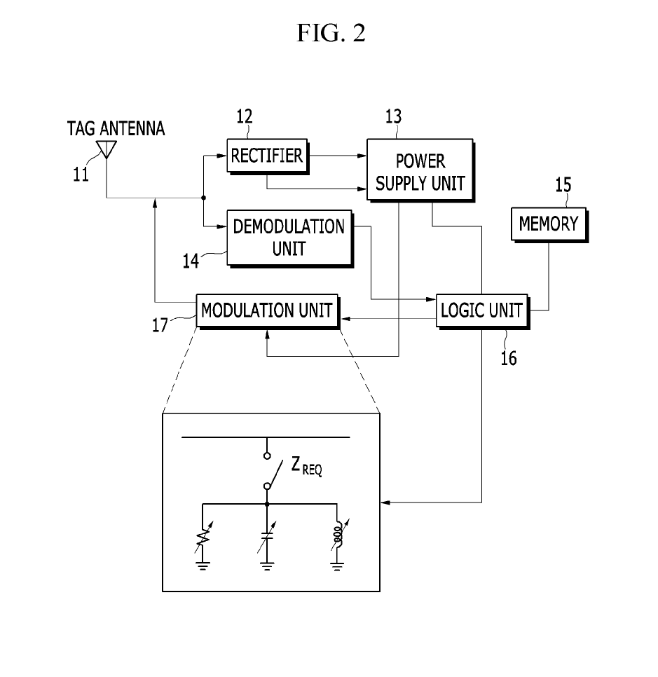

FIG. 2 is a diagram illustrating a structure of a tag apparatus, i.e., a tag according to an exemplary embodiment of the present invention.

As shown in FIG. 2, the tag 1 according to a first exemplary embodiment of the present invention includes a tag antenna 11, a rectifier 12, a power supply unit 13, a demodulation unit 14, a memory 15, a logic unit 16, and a modulation unit 17.

The tag antenna 11 receives a signal from the reader 2, and the rectifier 12 converts and outputs power of a signal, i.e., a radio frequency (RF) signal, received from the tag antenna 11 to a direct current (DC) voltage. The rectifier 12 includes a diode and a capacitor.

The power supply unit 13 supplies power to a tag, and may be formed with, for example, a capacitor. When the tag 1 is a battery support type of tag, the rectifier 12 and the power supply unit 13 operate through a separate battery.

The demodulation unit 14 demodulates a signal received from the tag antenna 11 and acquires a command of the reader 2. The demodulation unit 14 includes a diode and a capacitor, similar to the rectifier 12, and may use a capacitor having a small capacity compared with a capacitor (not shown) of the rectifier 12 for high speed signal processing.

Data is stored at the memory 15, and tag data that is related to a tag to provide to the reader 2 is stored at the memory 15.

The logic unit 16 performs an operation within the tag and performs demodulation of a reader command and encoding of tag data. The logic unit 16 according to an exemplary embodiment of the present invention controls the demodulation unit 14 to demodulate a command, i.e., a reader command, from a signal that is transmitted from the reader 2 and analyzes the demodulated reader command. When a demodulation process of the reader command is complete, the logic unit 16 generates a code for transmitting data that is stored at the memory 15 to the reader 2 according to the command.

In order to generate a code corresponding to a multi-level, the logic unit 16 according to an exemplary embodiment of the present invention loads data information in two variables of an amplitude and a phase, unlike an existing passive tag that transmits data only through a change of amplitude. That is, the logic unit 16 divides multi-level tag data information into an in-phase (I) channel and a quadrature-phase (Q) channel, represents it with one symbol, and transmits a multi-bit through one symbol using tag load impedance of a multi-level. For this purpose, the logic unit 16 converts tag data that is acquired from the memory 15 to a plurality of multi-level parallel data. The logic unit 16 previously recognizes bias voltage mapping information for load impedance of a multi-level and transfers a bias voltage corresponding to load impedance of a multi-level to the modulation unit 17. Bias mapping information is information in which bias voltages are mapped on a tag load impedance basis corresponding to each level.

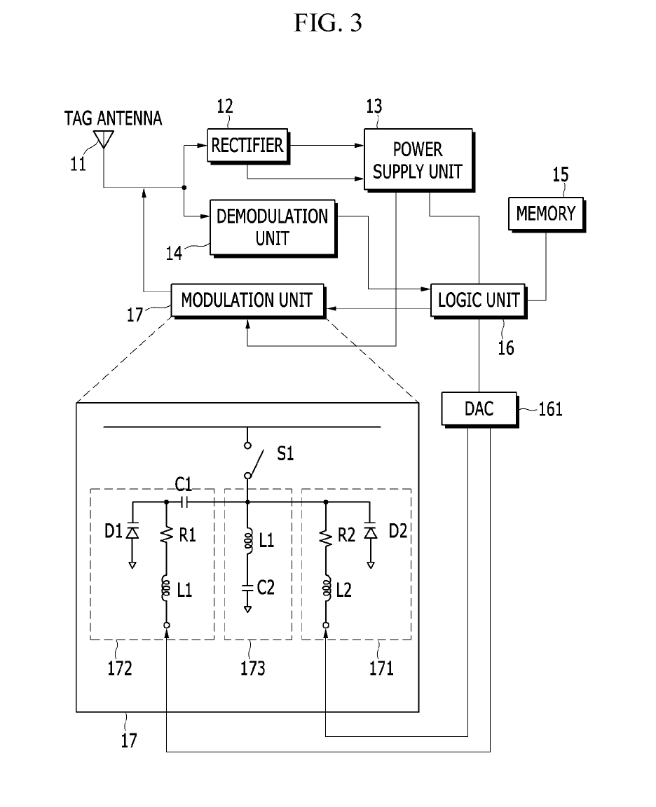

The logic unit 16 searches for a bias voltage corresponding to each level of a plurality of multi-level parallel data with reference to bias mapping information, and transfers the bias voltage to the modulation unit 17. In order to transfer a bias voltage, the logic unit 16 includes a digital-to-analog converter (DAC) (161 of FIG. 3).

The modulation unit 17 generates corresponding tag load impedance according to a bias voltage that is applied from the logic unit 16. Particularly, the modulation unit 17 receives a bias voltage from a DAC that is included in the logic unit 16, adjusts an impedance value according to the bias voltage, and generates multi-level tag load impedance.

FIG. 3 is a diagram illustrating a structure of a modulation unit of a tag according to an exemplary embodiment of the present invention.

The modulation unit 17 according to an exemplary embodiment of the present invention includes a variable resistor 171, a variable capacitor 172, a variable inductor 173, and a switch S1. The modulation unit 17 generates a plurality of tag load impedances corresponding to multiple levels through the variable resistor 171, the variable capacitor 172, and the variable inductor 173 that are formed as a variable lumped element component.

The variable capacitor 172 of the modulation unit 17 includes a varactor diode D1, a resistor R1, and an inductor L1 that are coupled in parallel to the varactor diode D1, and a capacitor C1 that is coupled in series to the varactor diode D1. The resistor R1 and the inductor L1 are coupled in series, and one side terminal of the inductor L1 is grounded. An anode terminal of the varactor diode D1 is grounded, and a cathode terminal of the varactor diode D1 is connected to one side terminal of the resistor R1 and one side terminal of the capacitor C1. The other side terminal of the capacitor C1 is connected to the switch S1.

The varactor diode D1 has a characteristic in which a physical width of a PN bonding depletion area changes according to a bias condition, and when an inverse bias voltage is applied to a PN bonding portion, the varactor diode D1 operates as a capacitor. Here, by adjusting a bias voltage that is applied to the varactor diode D1, the varactor diode D1 operates as a variable capacitor.

The variable inductor 173 of the modulation unit 17 includes an inductor L2 and a capacitor C2 that are coupled in series. One side of the inductor L2 is connected to the switch S1, and one side of the capacitor C2 is grounded. In addition, a value of the variable inductor may be varied through an active inductor. A gyrator may be used as the active inductor, and the gyrator generally includes two transconductors and a capacitor having opposite polarity. An active inductor including the gyrator provides a very large inductor value of tens of nanoHenries, and may adjust an inductance value with a bias current and thus a circuit is simple and may be easily integrated.

The variable resistor 171 of the modulation unit 17 includes a diode D2, and a resistor R2 and an inductor L3 that are coupled in parallel to the diode D2. The resistor R2 and the inductor L3 are coupled in series, one side terminal of the inductor L3 is grounded, and the other side terminal of the resistor R3 is connected to the switch S1. A cathode terminal of the diode D2 is grounded, and an anode terminal of the diode D2 is connected to one side terminal of the resistor R2.

The diode D2 is formed as a PIN diode. The PIN diode is formed to have a P-type or N-type area having very high intrinsic resistance added between the P-type and the N-type areas. When a backward bias voltage is applied, the PIN diode operates almost like a constant capacitor, and when a forward bias voltage is applied, the PIN diode operates like a variable resistor. Here, when a forward bias voltage is supplied to the diode D2 while being adjusted, the diode D2 operates as a variable resistor.

In an exemplary embodiment of the present invention, in this way, by adjusting a voltage that is applied to the varactor diode and the PIN diode of the modulation unit 17, tag load impedance is arbitrarily adjusted and thus multi-level backscattering modulation is performed.

Here, as a signal is provided to the tag antenna 11 through the switch S1, a signal having electrical energy corresponding to tag load impedance is transmitted to the reader 2 through the antenna 11.

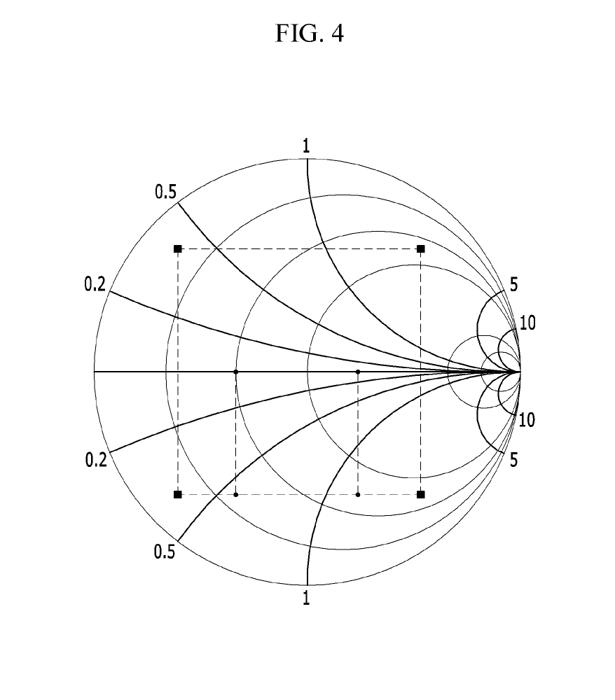

FIG. 4 is a Smith chart illustrating tag load impedance for multi-level modulation according to an exemplary embodiment of the present invention. The Smith chart of FIG. 4 shows tag load impedance for an M=4 level quadrature amplitude modulation (QAM) communication method.

QAM modulation is one of multi-level modulation methods, which are a kind of a digital modulation method, in which information of an amplitude and a phase of a carrier are combined and used. Because the method can load more data and information in one channel compared with an ASK or PSK communication method used in an existing passive RFID, high-rate data transmission is possible.

For example, in multi-level QAM with a modulation level M=4, tag load impedance of 4 symbols is as shown in FIG. 4. In FIG. 4, four square points of a quadrangle indicate tag impedance points for ideal four-level QAM modulation in a Smith chart, and for this purpose, both a real number value and an imaginary number value of impedance should be able to be controlled. Impedance may be generally represented as a component of a resistor, an inductor, and a capacitor, which are a lumped element. In FIG. 4, four circle points are tag impedance points that can be embodied with only component adjustment of the resistor and the capacitor in the lumped element.

As can be seen through such a Smith chart, in an exemplary embodiment of the present invention, by adjusting each impedance value of the variable resistor 171, the variable capacitor 172, and the variable inductor 173 of the modulation unit 17 in multiple levels, multi-level QAM modulation can be performed. The modulation unit 17 having such a structure may be referred to as a multi-level QAM backscattering modulation unit.

Accordingly, in an exemplary embodiment of the present invention, by transmitting a multi-bit with one symbol, high-rate data transmission is possible within a limited band. That is, because size and phase information can be transmitted together, compared with a tag having tag load impedance of two states, a plurality of bits can be transmitted with one symbol and thus an effect that a data transmission speed increases can be obtained.

When the tag 1 according to an exemplary embodiment of the present invention is a battery support type of tag, the tag 1 is in a standby state using a battery, and only when the tag 1 receives an activation command from the reader 2 does the tag 1 wake up and enter a normal mode. For this purpose, the battery support type tag includes a low power wake-up circuit that may operate with a minimal current.

Hereinafter, a communication method of a tag apparatus according to an exemplary embodiment of the present invention will be described based on such a structure.

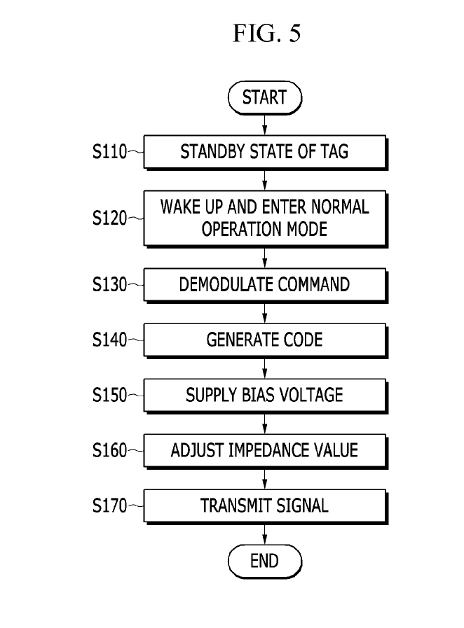

FIG. 5 is a flowchart illustrating a communication method of a tag apparatus according to an exemplary embodiment of the present invention.

As shown in FIG. 5, when the tag 1 in which high-rate data transmission is possible according to an exemplary embodiment of the present invention does not receive a signal from the reader 2, the tag 1 maintains a standby state (S110).

When an electromagnetic wave signal is transmitted from the reader 2, and the tag 1 receives the transmitted electromagnetic wave signal, the tag 1 rectifies the received electromagnetic wave signal through the rectifier 12 and converts the electromagnetic wave signal to DC power. From this time, the tag 1 wakes up and enters a normal operation mode (S120).

The tag 1 having entered a normal operation mode completes preparation to demodulate a command from the reader 2, demodulates a command that is included in a signal received from the reader 2, and analyzes the command (S130). The demodulation unit 14 demodulates a command that is included in the received signal according to the control of the logic unit 16, and transfers the command to the logic unit 16.

In order to transmit data that is stored at the memory 15 to the reader 2 according to the demodulated command analysis result, the tag 1 generates a code (S140). The logic unit 16 generates a data code for transmitting data that is stored at the memory 15 to the reader 2 according to a command.

In general, according to a UHF band passive RFID international standard, a passive tag encodes data with a FMO or Miller-modulated subcarrier, and determines an encoding method of a backward link using a variable that is included in a query command of the reader 2. In this case, unlike an existing passive tag that transmits data through only a change of amplitude, the tag 1 according to an exemplary embodiment of the present invention loads data information in two variables of an amplitude and a phase. That is, multi-level tag data information is divided into an I-channel and a Q-channel and is generated as one symbol. For this purpose, the logic unit 16 processes tag data to transmit it as a plurality of multi-level parallel data, supplies a bias voltage corresponding to each level of each data information to the modulation unit 17, and generates multi-level tag load impedance.

Specifically, the logic unit 16 generates multi-level codes for transmitting tag data, and in order to generate tag load impedance corresponding to the generated multi-level codes, it searches for a bias voltage corresponding to a level using mapping information, i.e., mapping information to which a bias voltage is mapped on a load impedance basis corresponding to each level of multiple levels, and supplies the bias voltage to the modulation unit 17 (S150).

The bias voltage is applied to each variable lumped element, i.e., the variable resistor 171, the variable capacitor 172, and the variable inductor 173 of the modulation unit 17, and thus each impedance value of the variable lumped element is adjusted (S160). Accordingly, the modulation unit 17 generates multi-level tag load impedance, and thus a signal having electrical energy corresponding to the tag load impedance is transmitted to the reader 2 (S170).

Therefore, by transmitting a multi-bit with one symbol according to multi-level code transmission, high-rate data transmission is possible within a limited band. The tag terminates an entire communication process with the reader through the process.

According to an exemplary embodiment of the present invention, in an RFID system, because high-rate data transmission is possible between a tag and a reader, a large number of individual products can be recognized at a high speed and read/write of a large amount of information is possible.

Further, because a tag can be switched with a plurality of load impedances, reflected electrical energy can be varied in multiple-levels. Therefore, because a multi-bit can be transmitted with one symbol, transmission speed can be improved compared with an existing passive RFID system.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tag apparatus, comprising:
a demodulation unit that demodulates and outputs a signal received from an antenna for transmitting/receiving a signal from a reader;
a memory that stores tag data to provide to the reader;
a logic unit that acquires a reader command from the demodulated signal, acquires data corresponding to the reader command from the memory, converts the acquired data to a plurality of multi-level parallel data, and outputs bias voltages that are mapped to the plurality of parallel data; and
a modulation unit that generates a plurality of tag load impedances according to bias voltages that are output from the logic unit.

2. The tag apparatus of claim 1, wherein the logic unit stores and manages bias mapping information to which bias voltages are mapped on a tag load impedance basis corresponding to each level, searches for a bias voltage corresponding to the level from the bias mapping information, and provides the bias voltage to the modulation unit.

3. The tag apparatus of claim 1, wherein the modulation unit comprises:
a variable capacitor that operates as a variable capacitor according to the bias voltage; and
a variable resistor that operates as a variable resistor according to the bias voltage,
wherein tag load impedance corresponding to different levels is generated by the variable capacitor and the variable resistor.

4. The tag apparatus of claim 3, wherein the modulation unit further comprises a variable inductor.

5. The tag apparatus of claim 3, wherein the variable capacitor comprises a varactor diode, and the variable resistor comprises a PIN diode.

6. A communication method of a tag apparatus, the communication method comprising:
receiving a signal from a reader and demodulating the received signal;
acquiring a reader command from the demodulated signal and converting data corresponding to the reader command to a plurality of multi-level parallel data;
providing bias voltages that are mapped to the plurality of parallel data to a modulation unit and generating a plurality of tag load impedances corresponding to the bias voltages; and
transmitting a signal having electrical energy corresponding to the tag load impedance to the reader.

7. The communication method of claim 6, wherein the generating of a plurality of tag load impedances comprises providing bias voltages that are mapped to each level of the plurality of parallel data to the modulation unit with reference to bias mapping information to which bias voltages are mapped on a tag load impedance basis corresponding to each level.

8. The communication method of claim 6, wherein the generating of a plurality of tag load impedances further comprises generating the plurality of tag load impedances using a PIN diode operating as a variable resistor according to a bias voltage and a varactor diode operating as a variable capacitor according to a bias voltage.
